(19) United States
(12) Patent Application Publication
(10) Pub. No.: US 2006/0057923 A1
(43) Pub. Date: Mar. 16, 2006

(54) Laminate products and methods of making the same

(76) Inventor: Alan Michael Jaffee, Bowling Green, OH (US)

Correspondence Address: JOHNS MANVILLE;Legal Department, 10100 West Ute Avenue, Littleton, CO, 80127, US

(21) Appl. No.: 10/938,827

(22) Filed: Sep. 10, 2004

(51) Int. Cl. B32B 17/00; B32B 5/26

(52) U.S. Cl. 442/381; 442/389; 442/415; 442/416; 156/62.2; 156/62.4; 162/123; 162/132; 162/141; 162/148; 162/156; 162/165; 162/166

(57) ABSTRACT

The present invention relates to laminate products comprising a non-wood cellulosic panel with at least one nonwoven fabric mat adhered thereto as well as to methods of making such laminate products.

### BACKGROUND OF THE INVENTION

1. Field of the Invention

The present invention relates to laminate products comprising a non-wood cellulosic panel with at least one nonwoven fabric mat adhered thereto as well as to methods of making such laminate products.

2. Description of the Related Art

It is known to make panels from cellulosic materials such as bark and straw using elevated heat and pressure. In general, such cellulosic panels, including “barkboard” and “strawboard” panels, are produced using particles (e.g., in the form of chips, shavings, fibers, flakes, wafers, or strands) that are mixed with a binder to form a furnish. The furnish is then formed into a mat that is compressed using a heated press or platens to produce a finished article such as a board.

It would be desirable to provide improved cellulosic panels comprising cellulosic particles.

### SUMMARY OF THE INVENTION

In one aspect, a laminate product is provided comprising a non-wood cellulosic panel and a nonwoven fabric mat adhered thereto. The panel has a first face, a second face, and edges and comprises non-wood cellulosic particles bonded together with a binder under heat and pressure. The nonwoven fabric mat is adhered to the first face of the non-wood cellulosic panel.

In another aspect, a method of making a laminate product is provided. The method comprises: (a) providing a non-wood cellulosic panel having a first face, a second face, and edges, the panel comprising non-wood cellulosic particles bonded together with a binder under heat and pressure; and (b) adhering a nonwoven fabric mat to the first face of the non-wood cellulosic panel.

In a further aspect, another method of making a laminate product is provided. The method comprises providing (a) a furnish comprising non-wood cellulosic particles and a binder and (b) at least one nonwoven fabric mat. A composite mat is formed using the furnish and the nonwoven fabric mat. The composite mat comprises (1) a mat formed from the furnish, the mat having a first face and a second face, and (2) the nonwoven fabric mat contacting the first face of the mat formed from the furnish. The composite mat is subjected to sufficient heat and pressure to form a laminate product comprising a non-wood cellulosic panel having a first face, a second face, and edges with the nonwoven fabric mat adhered to the first face of the non-wood cellulosic panel.

In yet another aspect, a laminate product is provided comprising a barkboard panel and a nonwoven fabric mat adhered thereto. The barkboard panel has a first face, a second face, and edges and comprises bark particles bonded together with a binder under heat and pressure. The nonwoven fabric mat is adhered to the first face of the barkboard panel.

In a further aspect, a laminate product is provided comprising a strawboard panel and a nonwoven fabric mat adhered thereto. The strawboard panel has a first face, a second face, and edges and comprises straw particles bonded together with a binder under heat and pressure. The nonwoven fabric mat is adhered to the first face of the strawboard panel.

### BRIEF DESCRIPTION OF THE DRAWINGS

FIG. 1 illustrates the results of testing, for various properties, a strawboard panel (control) and a strawboard panel with nonwoven glass mat facings (test) as explained below.

FIG. 2 illustrates a summary of the test results from FIG. 1.

### DETAILED DESCRIPTION OF PREFERRED EMBODIMENTS

The present invention relates to laminate products comprising a non-wood cellulosic panel with at least one nonwoven fabric mat adhered thereto as well as to methods of making such laminate products.

The non-wood cellulosic panels of the laminate products typically have a first face, a second face, and edges, and such panels may be in the form of boards, beams, or other forms and may be flat, nonflat, shaped, etc. The panels comprise non-wood cellulosic particles bonded together with a binder under heat and pressure.

The non-wood cellulosic particles of the panels may be in any form including, but not limited to, chips, shavings, fibers, flakes, wafers, strands, and combinations thereof. The non-wood cellulosic particles may be derived from any non-wood source including, but not limited to, straw (e.g., straw from wheat, oat, rice, barley, millet, rye, and combinations thereof), bark, hemp, bagasse, flax, nut shells, other agricultural products, recycled non-wood cellulosic materials, and combinations thereof.

In some embodiments, the non-wood cellulosic panels used with the laminate products include only non-wood cellulosic particles (i.e., without any wood particles). In other embodiments, the non-wood cellulosic panels may be constructed of substantially all non-wood cellulosic particles, but may also include some wood particles. In further embodiments, the non-wood cellulosic panels may be constructed of a majority of non-wood cellulosic particles, but may also include a minority of wood particles; for example, the non-wood cellulosic panels include hog fuel boards comprising mostly bark particles with some wood particles.

The non-wood cellulosic panels may also include non-cellulosic particles as well as other additives in addition to binder and non-wood cellulosic particles, although the panels may consist of non-wood cellulosic particles and binder. Such non-cellulosic particles that may be added include, but are not limited to, particles of glass, mica, rubber, and plastic. Additives that may be used include, but are not limited to, wax, preservatives, and release agents.

The binder used to bond the non-wood cellulosic particles (as well as any other particles) of the panel together may be any binding agent and may be or include a substance from the cellulosic particles that acts as a binder (e.g., resin in bark particles) when the particles are subjected to heat and pressure to form the non-wood cellulosic panel. Typical binders for such non-wood cellulosic panels include resins such as phenol formaldehyde resin, urea formaldehyde resin, melamine formaldehyde resin, and the like. Other binders that may be used include diisocyanate and polyisocyanate binders such as, for example, diphenyl methane diisocyanate (MDI) binder. In some embodiments, the only binder that is used is a substance from the cellulosic particles (such as, e.g., resin in bark particles). Mixtures of these binders may also be used.

In general, the non-wood cellulosic panels are produced using elevated heat and pressure (e.g., using a heated press with a pair of plates or a heated mold). The non-wood cellulosic particles (and any other particles such as wood or non-cellulose particles) are contacted with a binder (e.g., by mixing, spraying, etc.) to form a mixture or furnish. Any additional additives may also be added with or to the mixture. The amount of binder to be mixed with the non-wood cellulose particles (and any other particles or additives) may vary based upon variables such as the type, size, moisture content, and source of particles used, the binder that is used, and other variables. The furnish (i.e., the mixture of particles, binder, and any other additives) is then formed into a single or multi-layered mat with the particles (e.g., the non-wood cellulosic particles) in the mat (or in individual layers of a multi-layered mat) oriented or non-oriented. The mat may be formed in various ways, and the thickness of the mat may vary. The panel is then formed from the mat using sufficient heat and pressure. The press times, temperatures, and pressures used to form the panels may vary depending upon the desired thickness and density of the panels, the size and type of particles used, the binder that is used, as well as other variable factors.

Methods of making non-wood cellulosic panels are known. For example, methods for making various panels and boards are described in U.S. Pat. Nos. 5,656,129 (“Method of producing fibers from a straw and board products made therefrom”), U.S. Pat. No. 5,932,038 (“Method of fabricating a straw panel, board, or beam”), U.S. Pat. No. 6,120,914 (“Hog fuel board”), U.S. Pat. No. 6,458,238 (“Adhesive binder and synergist composition and process of making lignocellulosic articles”), U.S. Pat. No. 6,464,820 (“Binder resin and synergist composition including a parting agent and process of making lignocellulosic”), U.S. Pat. No. 6,544,649 (“Method for manufacturing an improved hog fuel board using a catalyst”), and U.S. Pat. No. 6,641,909 (“Hemp hurd composite panels and method of making”) as well as in U.S. patent application Publication Nos. 2003/0160349 (“Methods of straw fibre processing”) and 2002/0100565 (“Structural biocomposite materials, systems, and methods”); these U.S. patents and patent application publications are hereby incorporated by reference herein in their entirety.

The laminate products also include at least one nonwoven fabric mat adhered to a face of the non-wood cellulosic panel. As explained below, the mat may be adhered to the panel during or after formation of the panel. The nonwoven mats used to form the laminate products comprise fibers bonded together with a binder. In some embodiments, the nonwoven mats may consist of fibers and binder, and in other embodiments the nonwoven mats may include additional additives, such as pigments, dyes, flame retardants, water resistant agents, and/or other additives. Water resistant agents (i.e., water repellants) that may be used include, but are not limited to, stearylated melamine, fluorocarbons, waxes, asphalt, organic silicone, rubber, and polyvinyl chloride.

The fibers of the nonwoven mats may comprise glass fibers, polyester fibers (e.g., polyester spunbonded fibers), polyethylene terathalate (PET) fibers, other types of synthetic fibers (e.g., nylon, polypropylene, etc.), carbon fibers, ceramic fibers, metal fibers, or mixtures thereof. The fibers in the nonwoven mats may consist entirely of one of the previously mentioned types of fibers or may comprise one or more of the previously mentioned types of fibers along with other types of fibers such as, for example, cellulosic fibers or fibers derived from cellulose. The fibers used may be chosen to impart particular characteristics. For example, covering one or both sides of the product with nonwoven mats comprised primarily of inorganic fibers enhances the fire penetration resistance and reduces flame propagation. The nonwoven mat may also be reinforced within itself or on the surface with parallel strands, diagonal or box shaped reinforcements. These additional reinforcements may comprise glass yarn, filaments of plastic or metal.

The fibers may have various fiber diameters and lengths dependent on the strength and other properties desired in the mat. When polyester fibers are used, it is preferred that the denier of a majority of the fibers is in the range of 3 to 5. When glass fibers are used, it is preferred that a majority of the glass fibers have diameters in the range of 6 to 23 microns, more preferably in the range from 10 to 19 microns, even more preferably in the range of 11 to 16 microns. The glass fibers can be any type of glass including E glass, C glass, T glass, S glass, and other types of glass with good strength and durability in the presence of moisture.

Various binders may be used to bond the fibers together. Typically, binders are chosen that can be put into aqueous solution or emulsion latex and that are water soluble. As explained more fully below, the binders may be completely cured when forming the nonwoven mats or the binders may be “B” staged (i.e., only partially cured). When the binder in a nonwoven mat will be “B” staged, the binders preferably bind well to wood. Examples of binders that may be used for forming nonwoven mats with “B” staged binder include, but are not limited to, a furfuryl alcohol based resin, a phenol formaldehyde resin, a melamine formaldehyde resin, and mixtures thereof. When the mats will be completely formed (i.e., the binder will not be “B” staged), the binders may include, but are not limited to urea formaldehyde, melamine formaldehyde, phenol formaldehyde, acrylics, polyvinyl acetate, epoxy, polyvinyl alcohol, or mixtures thereof. Binders may also be chosen such that the binder is “formaldehyde free”, meaning that the binder contains essentially no formaldehyde (i.e., formaldehyde is not essential, but may be present as an impurity in trace amounts). Binder that may be used to provide formaldehyde free nonwoven mats include, but are not limited to polyvinyl alcohol, carboxy methyl cellulose, lignosulfonates, cellulose gums, or mixtures thereof. The nonwoven mat binder can also include a formaldehyde scavenger, which are known. Using formaldehyde scavengers in the binder dramatically slows the measurable formaldehyde release rate from the product.

Similarly, the nonwoven binder can include antimicrobial additives. Examples of suitable antimicrobial materials include zinc 2-pyrimidinethiol-1-oxide; 1-[2-(3,5-dichloro-phenyl)-4-propyl-[1,3]dioxo-lan-2-ylmethyl]-1H-[1,2,4]triazole; 4,5-dichloro-2-octyl-isothiazolidin-3-one; 5-chloro-2-(2,4-dichloro-phenoxy)-pheno-1,2-thiazol-4-yl-1H-benzoimidazole; 1-(4-chloro-phenyl)-4,4-dimethyl-3-[1,2,4]triazol-4-ylmethyl-pentan-3-ol; 10,10′oxybisphenoxarsine; 1-(diiodo-methanesulfonyl)-4-methyl-benzene and mixtures thereof. By encapsulating or surface covering the two surfaces of the wood sheathing panel with antimicrobial skins the entire product becomes more mold and mildew resistant. The skins can also include an additive such as borates that resist termites or other pests and provides additional fire resistance.

The nonwoven fabric mats may be made with varying ratios of the amount of fiber to the amount of binder in the mat. For example, in the “B” staged mats, it is preferable that the mats contain about 25-75 weight percent fibers and about 15-75 weight percent binder, more preferably 30-60 weight percent fibers and 40-70 weight percent binder. In mats made from formaldehyde free binder, it is preferred that the mats contain about 93-99.5 weight percent fibers and about 0.5-4 weight percent binder. However, other ratios of fiber to binder in the mats may be used for “B” staged mats, formaldehyde free mats, as well as non-“B” staged mats and other mats.

The nonwoven fabric mats may also be made to have varying thicknesses. Typical thicknesses for the mats range from 0.020 inches to 0.125 inches, although thicker and thinner mats may be used.

The nonwoven mats may further include a coating to impart water resistance (or waterproofness), flame resistance, insect resistance, mold resistance, a smooth surface, increased or reduced surface friction, desirable aesthetics, and/or other surface modifications. Coatings that may be used for waterproofing include organic waterproof coatings such as asphalt, organic silicone, rubber, and polyvinyl chloride. The coatings are preferably on the exterior side of the mats (i.e., the side that is not bound to the wood sheet product).

Any method for making nonwoven fabric mats may be used to provide the mats. Processes for making nonwoven fabric mats are well known. U.S. Pat. Nos. 4,112,174, 4,681,802 and 4,810,576, the entire contents of which are hereby incorporated herein by reference, describe methods of making nonwoven glass fabric mats. Methods of making “B” staged nonwoven mats are described in U.S. Pat. Nos. 5,837,620; 6,331,339; and 6,303,207 and U.S. patent application Publication No. 2001/0021448, the entire contents of which are incorporated by reference herein. Methods of making nonwoven mats using formaldehyde free binders are described in U.S. patent application Publication No. 2003/0008586, the entire content of which is incorporated by reference herein.

One technique for making the nonwoven mats that may be used is forming a dilute aqueous slurry of fibers and depositing the slurry onto an inclined moving screen forming wire to dewater the slurry and form a wet nonwoven fibrous mat, on machines like a Hydroformer™ manufactured by Voith—Sulzer of Appleton, Wis., or a Deltaformer™ manufactured by Valmet/Sandy Hill of Glenns Falls, N.Y. After forming a web from the fibrous slurry, the wet, unbonded mat is transferred to a second moving screen running through a binder application saturating station where the binder in aqueous solution is applied to the mat. The aqueous binder solution is preferably applied using a curtain coater or a dip and squeeze applicator. The excess binder is removed, and the wet mat is transferred to a moving oven belt that runs through a convection oven where the unbonded, wet mat is dried and cured, bonding the fibers together in the mat. The mat may be fully cured or may be cured to only a “B” stage. In the drying and curing oven the mat is heated to temperatures of up to about 350 degrees F., but this can vary from about 210 degrees F. to as high as any temperature that will not deteriorate the binder or, when a “B” stage cure is desired, to as high as any temperature that will not cure the binder beyond “B” stage cure. The treatment time at these temperatures can be for periods usually not exceeding 1 or 2 minutes and frequently less than 40 seconds. When curing the binder to a “B” stage, the lower the temperature that is used for the cure, the longer time required to reach “B” stage cure, although a temperature is normally selected such that the binder will reach “B” stage cure in no more than a few seconds.

The laminate products may be formed from the nonwoven fabric mats and the non-wood cellulosic panels by attaching at least one nonwoven fabric mat to a face of a non-wood cellulosic panel. The nonwoven fabric mat may be attached to a non-wood cellulosic panel either after completion of manufacture of the non-wood cellulosic panel or during manufacture of the non-wood cellulosic panel. When using a completed non-wood cellulosic panel and a nonwoven mat that has been completely cured (i.e., when the nonwoven mat is not in a “B” stage condition), an adhesive may be used to bind the completed non-wood cellulosic panel and the nonwoven mat together using sufficient pressure and heat to cure the adhesive. When using a completed non-wood cellulosic panel and a nonwoven mat that is in a “B” stage condition, the completed non-wood cellulosic panel and the nonwoven mat with a “B” stage condition binder are placed in contact and then subjected to heat and pressure to adhere the mat to the panel and to finish curing the “B” staged binder in the mat.

The laminate products may also be formed during manufacture of the non-wood cellulosic panel using a one-step application of heat and pressure. As discussed above, during formation of a non-wood cellulosic panel, a furnish comprising a mixture of non-wood cellulosic particles and binder is formed into a mat, which is then subjected to sufficient heat and pressure to cure the binder and form the completed panel. In order to form a laminate product during manufacture of the non-wood cellulosic panel (rather than after completion of the panel), a composite mat is formed using at least one nonwoven fabric mat and a furnish comprising non-wood cellulosic particles and a binder. The composite mat comprises (1) a mat formed from the furnish having a first face and a second face and (2) the nonwoven fabric mat contacting the first face of the mat formed from the furnish. When two nonwoven fabric mats are used with the furnish to form the composite mat, the composite mat may comprise (1) a mat formed from the furnish having a first face and a second face, (2) a first nonwoven fabric mat contacting the first face of the mat formed from the furnish, and (3) a second nonwoven fabric mat contacting the second face of the mat formed from the furnish. The composite mat could be formed by forming the mat from the furnish and then contacting the at least one nonwoven fabric mat to one of the faces of the mat formed from the furnish, or the composite mat could be formed by forming the mat from the furnish while the furnish is in contact with the at least one nonwoven fabric mat such that the nonwoven fabric mat is in contact with a face of the resulting mat formed from the furnish. After being formed, the composite mat is subjected to sufficient heat and pressure to form a laminate product comprising a non-wood cellulosic panel having a first face, a second face, and edges (made from the mat formed from the furnish) and the nonwoven fabric mat or mats adhered to the face or faces of the non-wood cellulosic panel. That is, the composite mat is subjected to sufficient heat and pressure to form the completed/cured non-wood cellulosic panel from the mat formed from the furnish as well as to adhere the nonwoven mat thereto. Thus, only one application of heat and pressure is used, rather than forming the non-wood cellulosic panel using a first application of heat and pressure and then performing a second application of heat and pressure to adhere a nonwoven fabric mat to the panel. The press times, temperatures, and pressures used to form the laminate product may vary depending upon the desired thickness and density of the panels, the size and type of particles used, the binder that is used, as well as other variable factors.

When a laminate product is formed using a one-step application of heat and pressure to a composite mat, “B” staged nonwoven fabric mats or fully cured nonwoven fabric mats may be used to form the laminate product. When a “B” staged nonwoven fabric mat is used in the composite mat, no additional binder or adhesive is typically needed to adhere the nonwoven mat to the non-wood cellulosic panel during the one-step application of heat and pressure (although such additional binder or adhesive may be used if desired); the pressure and heat that the composite mat is subjected to is sufficient to complete the cure of the binder in the “B” staged nonwoven mat and adhere the nonwoven fabric mat to the panel. When a nonwoven fabric mat is used that has been completely cured (i.e., when the nonwoven mat is not in a “B” stage condition), additional binder or adhesive may be used to adhere the nonwoven mat to the non-wood cellulosic panel that is formed during the one-step application of heat and pressure; the pressure and heat that the composite mat is subjected to is sufficient to complete the cure of the additional binder or adhesive and adhere the nonwoven mat to the completed panel. Such additional adhesive or binder may be added between the mat formed with the furnish (i.e., the mat comprising non-wood cellulosic particles and binder) and the nonwoven fabric mat, may be added to the furnish before forming the mat with the furnish, or may be added to the nonwoven fabric mat.

The nonwoven fabric mats to be used in the laminate products may be chosen such that they provide added or increased water resistance, mold and mildew resistance, strength (e.g., flexural strength or puncture resistance), dimensional stability, and/or flame resistance of the laminate product as compared to the non-wood cellulosic panels of the laminate products alone. That is, the nonwoven fabric mat(s) may be chosen such that one or more of these properties in the laminate product is greater than that of the non-wood cellulosic panel of the laminate product without the one or more nonwoven fabric mats adhered to the non-wood cellulosic panel.

In addition, the nonwoven fabric mats to be used in the laminate products may also be chosen such that they provide increased strength (e.g., flexural strength), increased dimensional stability, increased water resistance, increased mold resistance, increased flame resistance, and/or reduced weight to the laminate product as compared to a non-wood cellulosic panel of the same type used in the laminate product with comparable dimensions to the completed laminate product (i.e., the same size of the laminate product).

### EXAMPLE

The invention will be further explained by the following illustrative example that is intended to be non-limiting.

A strawboard panel (control) and a strawboard panel with nonwoven glass mat facings (test) were manufactured and tested in order to measure their strength and moisture resistance. More specifically, the boards that were tested were as follows:
(1) strawboard panel with glass mat facings (made using furfuryl alcohol formaldehyde as the binder) on each side of the panel; and
(2) strawboard with no nonwoven facing (i.e., the control).

Two “B” staged nonwoven glass mats were used to make the laminate product to be tested. The “B” staged nonwoven glass mats used for the test board were formed using a conventional wet lay process. The basis weight of the glass mats was 6 lbs./1 00 ft.², with the mats made with approximately 60% binder and 40% fibers. The glass fibers used in the glass mats were E glass fibers having average fiber diameters of 16 microns and an average length of 1 inch.

Both the test board and the control board were prepared using a 34″×34″ forming box. Split wheat straw and isocyanate binder (MDI) were used for the strawboard panels of the control and test boards. To form the control board, the split wheat straw furnish was hand formed into a mat using the forming box. To form the test board, the split wheat straw furnish and the “B” staged nonwoven mats were hand formed into a composite mat using the forming box (with the furnish sandwiched between the two nonwoven glass mats). The hand formed mats were then pressed using a typical oriented strand board (OSB) press cycle. All parameters were based on typical OSB commercial values as summarized in the table below.

| | |
|---|---|
| Target Dimensions (inches) | 28 × 28 × 0.437 |
| Target Density (lbs./ft.³) | 39.0 |
| Mat Construction | Oriented Face/core ratio - 50/50 |
| Resin Type | Face: Isocyanate resin (MDI), 5.0% solids |
| | Core: Isocyanate resin (MDI), 5.0% solids |
| Wax Type | Slack Wax 1% solids |
| Press Temperature | 400 |
| (degrees Fahrenheit) | |

The panels were pressed to the target thickness of 0.437″. The panels were pressed for approximately 266-289 seconds at a press temperature of 400° F. The resulting boards were trimmed to approximately 28″×28″.

B. Measurements

The test board and the control board were measured for the following properties in order to assess strength and moisture resistance, with the number of samples per board that were tested listed in parentheses after the description of the test:
(1) modulus of rupture (MOR) in the parallel direction of the strawboard (MOR para), measured in pounds per square inch (psi) (3 samples per board tested);
(2) modulus of rupture in the perpendicular direction of the strawboard (MOR perp), measured in psi (3 samples per board tested);
(3) modulus of elasticity (MOE) in the parallel direction of the strawboard (MOE para), measured in psi (3 samples per board tested);
(4) modulus of elasticity in the perpendicular direction of the strawboard (MOE perp), measured in psi (3 samples per board tested);
(5) internal bond, measured in psi (6 samples per board tested);
(6) bond durability in the parallel direction of the strawboard measured as the modulus of rupture after 2 hours of boiling a sample of a board, measured in psi (3 samples per board tested);
(7) bond durability in the perpendicular direction of the strawboard measured as the modulus of rupture after 2 hours of boiling a sample of a board, measured in psi (3 samples per board tested);
(8) thickness swell percentage after 24 hours of soaking a sample of a board in water (2 samples per board tested);
(9) water absorption after 24 hours of soaking a sample of a board in water, measured as percentage (2 samples per board tested);
(10) linear expansion in the parallel direction of the strawboard from oven dry to saturated using a vacuum pressure soak, measured as percentage (2 samples per board tested); and
(11) linear expansion in the perpendicular direction of the strawboard from oven dry to saturated using a vacuum pressure soak, measured as percentage (2 samples per board tested).

Each of properties (1)-(1 1) listed above was evaluated using Canadian Standards Association (CSA) test standard 0437.1-93.

C. Results

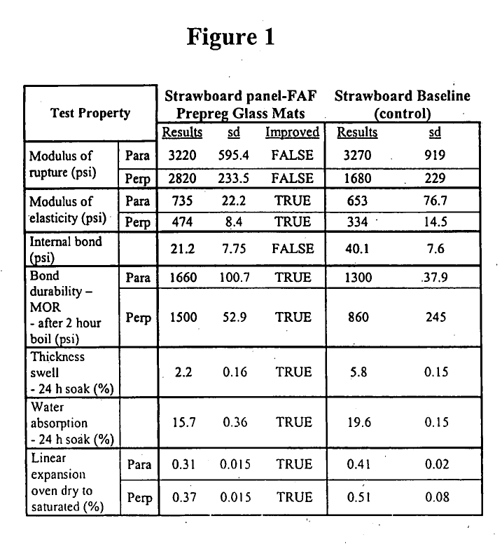

The results of the measurements of the properties of the test board and the control board are shown in FIG. 1. FIG. 1 lists the results of the tests, the standard deviation (sd) of the tests, and an indication of whether the results for the test board were improved versus the control board (i.e., Strawboard Baseline) at a statistically significant level (i.e., a 95% confidence level) using the Student's T-test (indications were given as True or False).

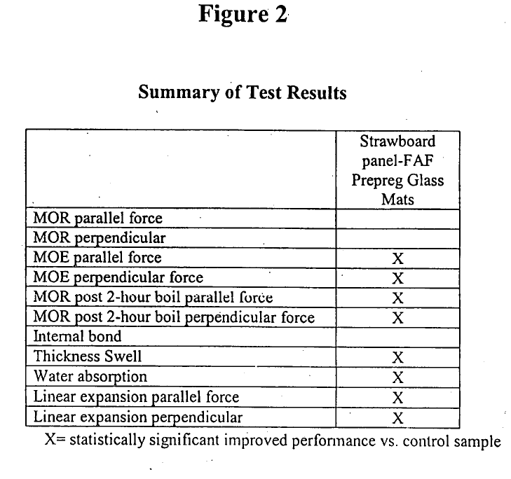

The results illustrate increased strength and moisture resistance in the test board. FIG. 2 summarizes the results showing the statistically significant improvements that were made to the strength and water resistance in the test board versus the control board.

While the invention has been described in detail and with reference to specific embodiments thereof, it will be apparent to one skilled in the art that various changes and modifications can be made without departing from the spirit and scope of the invention.

What is claimed is:

1. A laminate product comprising:
a non-wood cellulosic panel having a first face, a second face, and edges, the panel comprising non-wood cellulosic particles bonded together with a binder under heat and pressure; and
a nonwoven fabric mat adhered to the first face of the non-wood cellulosic panel.

2. The laminate product of claim 1, further comprising a second nonwoven fabric mat adhered to the second face of the non-wood cellulosic panel.

3. The laminate product of claim 1, wherein the nonwoven fabric mat is selected from the group consisting of a glass fiber nonwoven mat and a polyester fiber nonwoven mat.

4. The laminate product of claim 1, wherein the non-wood cellulosic particles are selected from the group consisting of straw particles, bark particles, and mixtures thereof.

5. The laminate product of claim 1, wherein the binder is selected from the group consisting of phenol formaldehyde resin, urea formaldehyde resin, melamine formaldehyde resin, diisocyanate binder, polyisocyanate binder, and mixtures thereof.

6. The laminate product of claim 1, wherein the binder comprises a substance of the non-wood cellulosic particles.

7. The laminate product of claim 1, wherein the mat comprises fibers bonded together with a formaldehyde free binder.

8. The laminate product of claim 1, wherein the mat comprises a fungicide, pesticide, fire retardant or mixture thereof.

9. The laminate product of claim 1, wherein the laminate product is produced by subjecting the panel and a “B” stage condition nonwoven fabric mat to sufficient heat and pressure to complete the cure of the binder in the mat and to adhere the mat to the panel, the “B” stage condition mat comprising fibers bonded together with a resin binder that is only partially cured.

10. A method of making a laminate product comprising the steps of:
(a) providing a non-wood cellulosic panel having a first face, a second face, and edges, the panel comprising non-wood cellulosic particles bonded together with a binder under heat and pressure; and
(b) adhering a nonwoven fabric mat to the first face of the non-wood cellulosic panel.

11. The method of claim 10, further comprising adhering a nonwoven fabric mat to the second face of the non-wood cellulosic panel.

12. The laminate product of claim 10, wherein the nonwoven fabric mat is selected from the group consisting of a glass fiber nonwoven mat and a polyester fiber nonwoven mat.

13. The laminate product of claim 10, wherein the non-wood cellulosic particles are selected from the group consisting of straw particles, bark particles, and mixtures thereof.

14. The laminate product of claim 10, wherein the binder is selected from the group consisting of phenol formaldehyde resin, urea formaldehyde resin, melamine formaldehyde resin, diisocyanate binder, polyisocyanate binder, and mixtures thereof.

15. The laminate product of claim 10, wherein the binder comprises a substance of the non-wood cellulosic particles.

16. The method of claim 10, wherein step (b) comprises subjecting the panel and a “B” stage condition nonwoven fabric mat to sufficient heat and pressure to complete the cure of the binder in the mat and to adhere the mat to the panel, the “B” stage condition mat comprising fibers bonded together with a resin binder that is only partially cured.

17. The method of claim 10, wherein the mat comprises fibers bonded together with a formaldehyde free binder.

18. A method of making a laminate product comprising the steps of:
(a) providing a furnish comprising non-wood cellulosic particles and a binder;
(b) providing at least one nonwoven fabric mat;
(c) forming a composite mat using the furnish and the nonwoven fabric mat, the composite mat comprising:
(1) a mat formed from the furnish, the mat having a first face and a second face; and
(2) the nonwoven fabric mat contacting the first face of the mat formed from the furnish; and
(d) subjecting the composite mat to sufficient heat and pressure to form a laminate product comprising a non-wood cellulosic panel having a first face, a second face, and edges with the nonwoven fabric mat adhered to the first face of the non-wood cellulosic panel.

19. The method of claim 18, wherein the composite mat further comprises a second nonwoven fabric mat contacting the second face of the mat formed from the furnish and step (d) results in a laminate product comprising the non-wood cellulosic panel with the nonwoven fabric mat adhered to the first face of the panel and the second nonwoven mat adhered to the second face of the panel.

20. The method of claim 18, wherein the nonwoven fabric mat is selected from the group consisting of a glass fiber nonwoven mat and a polyester fiber nonwoven mat.

21. The method of claim 18, wherein the non-wood cellulosic particles are selected from the group consisting of straw particles, bark particles, and mixtures thereof.

22. The method of claim 18, wherein the binder is selected from the group consisting of phenol formaldehyde resin, urea formaldehyde resin, melamine formaldehyde resin, diisocyanate binder, polyisocyanate binder, and mixtures thereof.

23. The method of claim 18, wherein the binder comprises a substance of the non-wood cellulosic particles.

24. The method of claim 18, wherein the nonwoven fabric mat is a “B” stage condition nonwoven fabric mat comprising fibers bonded together with a resin binder that is only partially cured.

25. The method of claim 18, wherein the mat comprises fibers bonded together with a formaldehyde free binder.

26. A laminate product comprising:
a barkboard panel having a first face, a second face, and edges, the barkboard panel comprising bark particles bonded together with a binder under heat and pressure; and
a nonwoven fabric mat adhered to the first face of the barkboard panel.

27. The laminate product of claim 26, further comprising a second nonwoven fabric mat adhered to the second face of the barkboard panel.

28. The laminate product of claim 26, wherein the nonwoven fabric mat is selected from the group consisting of a glass fiber nonwoven mat and a polyester fiber nonwoven mat.

29. The laminate product of claim 26, wherein the laminate product is produced by subjecting the panel and a “B” stage condition nonwoven fabric mat to sufficient heat and pressure to complete the cure of the binder in the mat and to adhere the mat to the panel, the “B” stage condition mat comprising fibers bonded together with a resin binder that is only partially cured.

30. A laminate product comprising:
a strawboard panel having a first face, a second face, and edges, the strawboard panel comprising straw particles bonded together with a binder under heat and pressure; and
a nonwoven fabric mat adhered to the first face of the strawboard panel.

31. The laminate product of claim 30, further comprising a second nonwoven fabric mat adhered to the second face of the strawboard panel.

32. The laminate product of claim 30, wherein the nonwoven fabric mat is selected from the group consisting of a glass fiber nonwoven mat and a polyester fiber nonwoven mat.

33. The laminate product of claim 30, wherein the mat comprises a fungicide, pesticide, fire retardant or mixture thereof.

34. The laminate product of claim 30, wherein the laminate product is produced by subjecting the panel and a “B” stage condition nonwoven fabric mat to sufficient heat and pressure to complete the cure of the binder in the mat and to adhere the mat to the panel, the “B” stage condition mat comprising fibers bonded together with a resin binder that is only partially cured.
